(19) United States
(12) Patent Application Publication
(10) Pub. No.: US 2023/0036127 A1
(43) Pub. Date: Feb. 2, 2023

(54) Adjustable Myofascial Release Device

(71) Applicant: Josh Dunn, Cumming, GA (US)

(72) Inventor: Josh Dunn, Cumming, GA (US)

(21) Appl. No.: 17/390,974

(22) Filed: Aug. 1, 2021

(51) Int. Cl. A61H 15/00

(52) U.S. Cl. CPC A61H 15/00; A61H 2015/0014; A61H 2201/0119; A61H 2201/0161

(57) ABSTRACT

Disclosed is an adjustable myofascial release device that includes a compression roller; a plurality of rods; and a plurality of releasing hinges. The rods are connected with the compression roller. The releasing hinges are adjusted by a user and adaptable to receive pressure from the user. Each of the releasing hinges is fixed at a distal end of the rods. The releasing hinges are attached to the compression roller and the rods by a plurality of locking mechanisms.

### TECHNICAL FIELD

The presently disclosed embodiments are related, in general, to an adjustable myofascial release device. More particularly, the presently disclosed embodiments are related to the adjustable full-body myofascial release roller.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in-and-of-themselves may also be inventions.

Typically, myofascial pain is identified by trigger points and tight myofascial fascia which is the most common cause of muscle aches and pain. Health professionals involved in the treatment of myofascial pain include but are not limited to physicians, chiropractors, physical therapists, and massage therapists. Also, myofascial pain is treated via pressure, either directed through the hands or various tools.

U.S. Pat. No. 8,449,438B2 issued to Morin talks about an adjustable standing muscular releasing and stretching exercise device for a user. The device has a vertical linear column base, a support handle that can be vertically moved and attached along the linear base, a pair of adjustable releasing rollers on a horizontal bar with a roller connection that is movably connected to the linear base, a horizontal floor base that is attached to and supports the linear base, a raised non-skid foot platform that is attached to and extends over said floor base and an adjustable non-skid calf step perpendicularly and slidably attached to said foot platform.

However, the existing devices do not adjust for individual strength ability and height. This difference allows almost all health professionals to use the device and allows muscle tissue to adapt faster with better change in overall tissue. This specification recognizes that there is a necessity for an adjustable full-body myofascial release hinge.

Thus, in view of the above, there is a long-felt need in the health industry to address the aforementioned deficiencies and inadequacies.

Further limitations and disadvantages of traditional approaches will become apparent to one of skill in the art, through comparison of described embodiments with some aspects of the present disclosure, as set forth in the remainder of the present application and with reference to the drawings.

### SUMMARY

According to embodiments illustrated herein, there may be provided an adjustable myofascial release device that includes a compression roller; a platform, a plurality of rods; and a plurality of releasing hinges. The rods are connected with the compression roller. The releasing hinges are adjusted by a user and adaptable to receive pressure from the user. Each of the releasing hinges are fixed at a distal end of the rods. The releasing hinges are attached to the compression roller and the rods by a plurality of locking mechanisms.

In an aspect, the adjustable myofascial release device includes a platform attached to and supports the compression roller and the rods.

In an aspect, the platform includes a receiving area such as a cutout to receive the compression roller.

In an aspect, the receiving area allows the compression roller to collapse in a closed position.

In an aspect, the rods are slidably attached to the compression roller.

In an aspect, the rods are adaptable to move inwards.

In an aspect, the lengths of the rods are maximized to provide stability on the platform.

In an aspect, the adjustable myofascial release device is adapted for use by a user in a vertical position.

In an aspect, the releasing hinges are configured to facilitate the user to rotate the releasing hinges back and forth or move local extremities around while on muscle spot upon achieving a desired pressure.

In an aspect, the adjustable myofascial release device is adjustable to various heights.

In an aspect, the adjustable myofascial release device is collapsible to allow the user to perform an easy transportation.

In an aspect, the adjustable myofascial release device includes at least two stabilizer rods configured to retract and extended upward once installed on the platform.

In an aspect, the adjustable myofascial release device includes at least two holes on either side of the platform for inserting the stabilizer rods.

In an aspect, the platform at the receiving area is made in two separate parts with a locking pin designed to hold the separate parts of the platform when in use.

In an aspect, the adjustable myofascial release device includes at least two recessed slots placed along both ends of the platform to secure the two stabilizer rods on either end for ease of storage, wherein the recessed slots comprising a small notch for finger insertion for removal of the two stabilizer rods.

Accordingly, one advantage of the present invention is that it helps to relieve muscle tension spots and increase tissue/joint mobility.

Accordingly, one advantage of the present invention is that it increases the ability to move freely.

Accordingly, one advantage of the present invention is that it adjusts to different heights and it is also collapsible which allows it to be easily transportable and stored away if needed.

Accordingly, one advantage of the present invention is that it depends on which muscle area wanting to be worked, and the user i.e., a customer would adjust the releasing hinges to the proper height and apply pressure into the releasing roller. Once desired pressure is achieved, the user can either roll back and forth on the roller or move local extremities around while on muscle spot.

Accordingly, one advantage of the present invention is that it increases joint and tissue mobility.

Accordingly, one advantage of the present invention is that it increases athletic performance.

Accordingly, one advantage of the present invention is that it increases muscle contraction/strength.

Accordingly, one advantage of the present invention is that it increases overall freedom of movement.

Accordingly, one advantage of the present invention is that it increases motor control coordination.

These and other features and advantages of the present disclosure may be appreciated from a review of the following detailed description of the present disclosure, along with the accompanying figures in which reference numerals refer to like parts throughout.

### BRIEF DESCRIPTION OF DRAWINGS

The accompanying drawings illustrate the various embodiments and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a perspective view of an adjustable myofascial release device, in accordance with at least one embodiment.

FIG. 2 is a side view of the adjustable myofascial release device, in accordance with at least one embodiment.

FIG. 3 is an aerial view of the adjustable myofascial release device, in accordance with at least one embodiment.

FIG. 4 is a perspective side-view of the adjustable myofascial release device to depict the small notch as well as the recessed storage area for the stabilizer rods, in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the apparatuses, methods, and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Reference throughout this document to “stabilizer rods”, or similar terms refers to rods that a user will hold during use of the embodiment that allows the user to remain in a stable position while utilizing the device. Thus, the appearances of such phrases or in various places throughout this specification are not necessarily all referring to the same embodiment. Furthermore, the particular features, structures, or characteristics may be combined in any suitable manner in one or more embodiments without limitation.

Headings of sections provided in this patent application and the title of this patent application are for convenience only and are not to be taken as limiting the disclosure in any way. A description of an embodiment with several components in connection with each other does not imply that all such components are required.

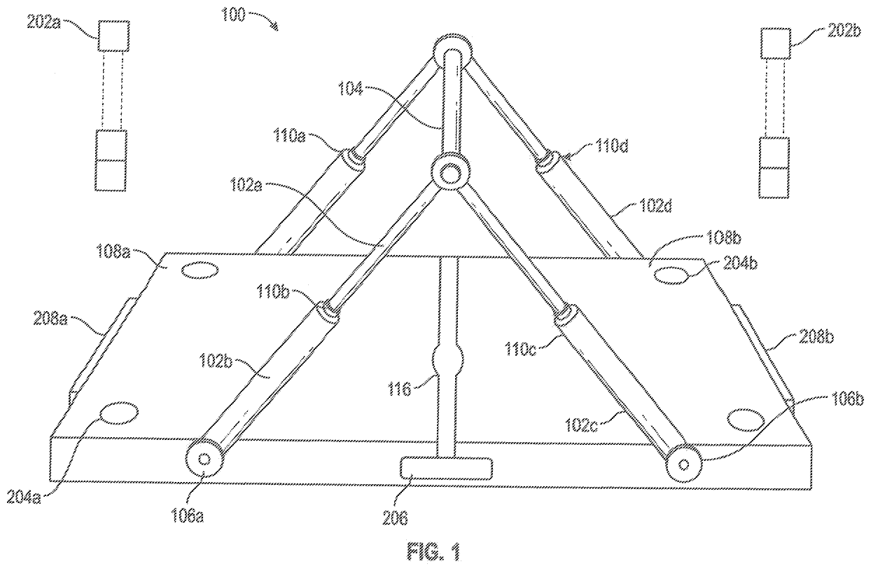

FIG. 1 is a perspective view of an adjustable myofascial release device (100), in accordance with at least one embodiment. The adjustable myofascial release device (100) includes a compression roller (104); a plurality of rods (102a, 102b, 102c, and 102d); and a plurality of releasing hinges (106a, 106b, 106c, and 106d). The rods (102a, 102b, 102c, and 102d) are connected with the compression roller (104). The releasing hinges (106a, 106b, 106c, and 106d) are adjusted by a user and adaptable to receive pressure from the user. Each of the releasing hinges (106a, 106b, 106c, and 106d) is fixed at a distal end of the rods (102a, 102b, 102c, and 102d). The releasing hinges (106a, 106b, 106c, and 106d) are attached to the compression roller (104) and the rods (102a, 102b, 102c, and 102d) by a plurality of locking mechanisms (110a, 110b, 110c, and 110d). In an embodiment, the releasing hinges (106a, 106b, 106c, and 106d) are configured to facilitate the user to rotate (202) the releasing hinges (106a, 106b, 106c, and 106d) back and forth or move local extremities around while on muscle spot upon achieving a desired pressure.

In an embodiment, the rods (102a, 102b, 102c, and 102d) are slidably attached to the compression roller (104). In an embodiment, the adjustable myofascial release device (100) includes a platform (108) attached to and supports the compression roller (104) and the rods (102a, 102b, 102c, and 102d).

In an embodiment, the platform (108) includes a receiving area (116) such as a cutout to receive the compression roller (104). In an embodiment, the receiving area (116) allows the compression roller (104) to collapse in a closed position. In an embodiment, the rods (102a, 102b, 102c, and 102d) are adaptable to move inwards. In an aspect, the length of the rods (102a, 102b, 102c, and 102d) are maximized to provide stability on the platform (108).

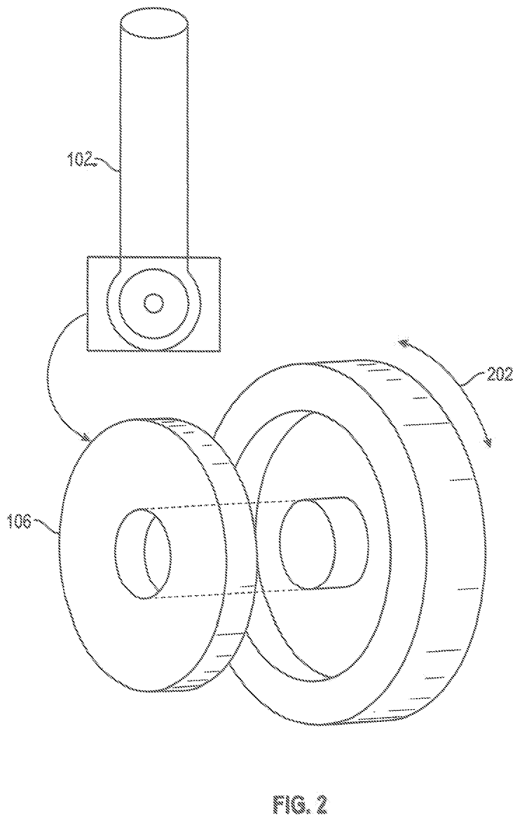

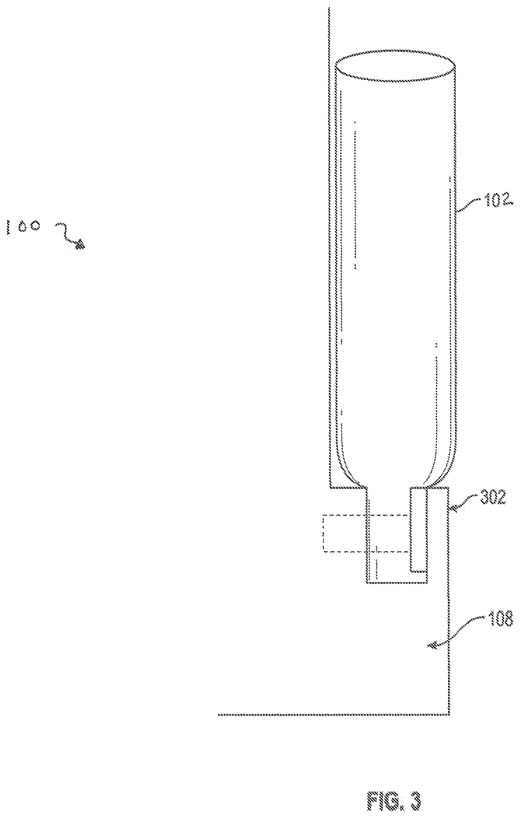

FIG. 2 is a side view of the adjustable myofascial release device (100), in accordance with at least one embodiment. In an embodiment, the adjustable myofascial release device (100) is adapted for use by a user in a vertical position. In an embodiment, the adjustable myofascial release device (100) is adjustable to various heights. FIG. 3 is an aerial view of the adjustable myofascial release device (100), in accordance with at least one embodiment. In an embodiment, the adjustable rod (102) is collapsible to allow the user to perform an easy transportation. The aerial view of the adjustable rod (102) depicts a rotation point (302) that allows the myofascial release device to be positioned in a manner to massage the user's body part when he is in a vertical position or lied on the platform (108).

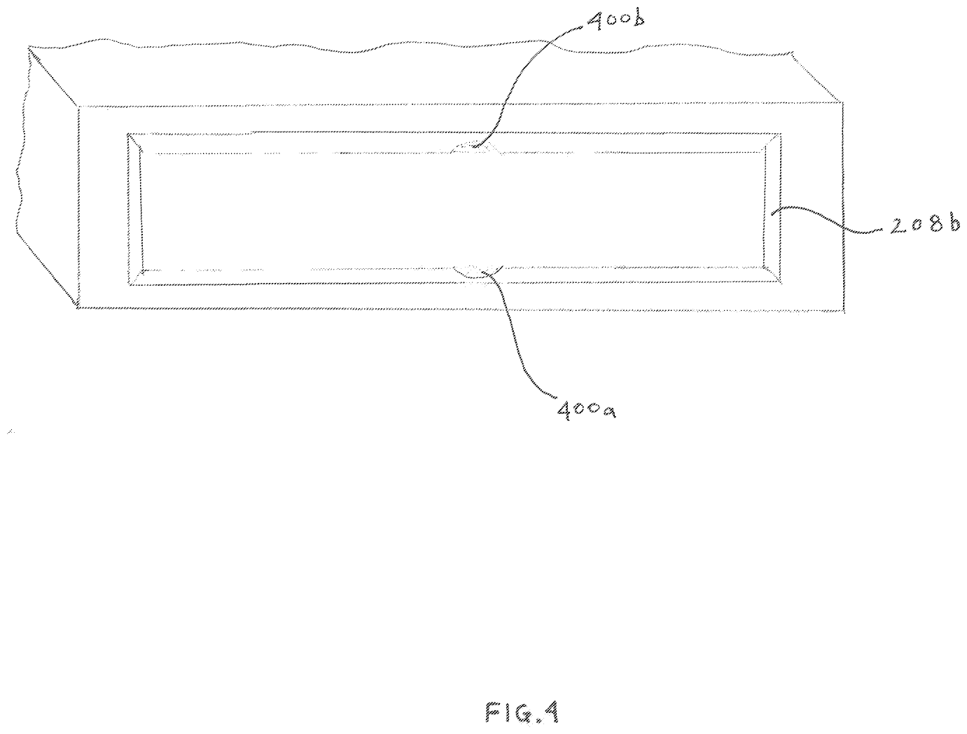

In an embodiment, the adjustable myofascial release device (100) includes at least two stabilizer rods (202a and 202b) configured to retract and extended upward once installed on the platform (108). In an embodiment, the adjustable myofascial release device (100) includes at least two holes (204a and 204b) on either side of the platform (108) for inserting the stabilizer rods. In an embodiment, the platform (108) at the receiving area (116) is made in two separate parts (108a and 108b) with a locking pin (206) designed to hold the separate parts of the platform (108) when in use. In an embodiment, the adjustable myofascial release device (100) includes at least two recessed slots (208a and 208b) placed along both ends of the platform (108) to secure the two stabilizer rods (202a and 202b) on either end for ease of storage, wherein the recessed slots comprising small notchs (400a and 400b) for finger insertion for removal of the two stabilizer rods (202a and 202b). FIG. 4 is a perspective side view of the adjustable myofascial release device (100), in accordance with at least one embodiment. In an embodiment, the small notch (400a and 400b) is two grooved cavity areas designed inside the opening of the recessed slot (208b) to allow the application of a user's fingers to conveniently remove or insert the stabilizer rods into the recessed slot (208b). The small notch (400a and 400b) allows the user to conveniently grip the stabilizer rods.

Thus, the present invention provides an adjustable myofascial release device that helps to relieve muscle tension spots and increase tissue/joint mobility. Further, the adjustable myofascial release device increases the ability to move freely. Furthermore, the adjustable myofascial release device adjusts to different heights and it is also collapsible which allows it to be easily transportable and stored away if needed. Furthermore, the adjustable myofascial release device depends on which muscle area wanting to be worked, and the user i.e., a customer would adjust the releasing hinges to the proper height and apply pressure into the releasing roller. Once desired pressure is achieved, the user can either roll back and forth on the roller or move local extremities around while on muscle spot. Additionally, the adjustable myofascial release device increases joint and tissue mobility. Additionally, the adjustable myofascial release device increases athletic performance, muscle contraction/strength, overall freedom of movement, and motor control coordination.

A person skilled in the art will understand that the adjustable myofascial release device (100) is described herein for illustrative purposes and should not be construed to limit the scope of the disclosure. [symbol] any manner. It will be further appreciated that the variants of the above-disclosed system elements, modules, and other features and functions, or alternatives thereof, may be combined to create other different apparatuses, systems, or applications.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. An adjustable myofascial release device, comprising:
a compression roller;
a plurality of rods connected with the compression roller;
a platform; and
a plurality of releasing hinges adjustable by a user and adaptable to receive pressure from the user, wherein each of the releasing hinges are fixed at a distal end of the rods.

2. The adjustable myofascial release device as claimed in claim 1, wherein the releasing hinges are attached to the compression roller and the rods by a plurality of locking mechanisms.

3. The adjustable myofascial release device as claimed in claim 2, comprising a platform attached to and supports the compression roller and the rods.

4. The adjustable myofascial release device as claimed in claim 2, wherein the platform comprises a receiving area to receive the compression roller.

5. The adjustable myofascial release device as claimed in claim 4, wherein the receiving area allows the compression roller to collapse in a closed position.

6. The adjustable myofascial release device as claimed in claim 1, wherein the rods are slidably attached to the compression roller.

7. The adjustable myofascial release device as claimed in claim 1, wherein the rods adaptable to move inwards.

8. The adjustable myofascial release device as claimed in claim 1, wherein the length of the rods are maximized to provide stability on the platform.

9. The adjustable myofascial release device as claimed in claim 1 is adapted for use by a user in a vertical position.

10. The adjustable myofascial release device as claimed in claim 1, wherein the plurality of releasing hinges figured to facilitate the user to rotate the releasing hinges back and forth or move local extremities around while on muscle spot upon achieving a desired pressure.

11. The adjustable myofascial release device as claimed in claim 1 is adjustable to a plurality of heights.

12. The adjustable myofascial release device as claimed in claim 1 is collapsible to allow the user to perform an easy transportation.

13. The adjustable myofascial release device as claimed in claim 1, comprising at least two stabilizer rods configured to retract and extended upward once installed on the platform.

14. The adjustable myofascial release device as claimed in claim 13, comprising at least two holes on either side of the platform for inserting the stabilizer rods.

15. The adjustable myofascial release device as claimed in claim 3, wherein the platform at the receiving area is made in two separate parts with a locking pin designed to hold the separate parts of the platform when in use.

16. The adjustable myofascial release device as claimed in claim 1, comprising at least two recessed slots placed along both ends of the platform to secure the two stabilizer rods on either end for ease of storage, wherein the recessed slots comprising a small notch for finger insertion for removal of the two stabilizer rods.
